(19) United States
(12) Patent Application Publication
(10) Pub. No.: US 2008/0035729 A1
(43) Pub. Date: Feb. 14, 2008

(54) Multiple Card Reading Modules Apparatus

(76) Inventors: Wei-Jung Lin, Taipei (TW); Chih-Hsu Tsai, Taipei (TW); Chih-Ching Liao, Taipei (TW)

Correspondence Address: LAW OFFICES OF LAI AND ASSOCIATES, P.C., 5800 RANCHESTER STE 200, HOUSTON, TX, 77036, US

(21) Appl. No.: 11/463,435

(22) Filed: Aug. 9, 2006

(51) Int. Cl. G06K 7/00

(52) U.S. Cl. 235/440; 235/439

(57) ABSTRACT

A multiple card reading modules apparatus includes a first card reading module and a second card reading module. The first card reading module includes a card receiving structure. The first card reading module reads a first card signal based on a control signal through the card receiving structure. The second card reading module is combined with the first card reading module through a combination device for sharing the card receiving structure to read a second card signal and generate the control signal based on the content of the second card signal.

### FIELD OF THE INVENTION

The present invention relates to a multiple card reading modules apparatus, and more particularly to a multiple card reading modules apparatus of which different card reading modules share a common card receiving structure.

### BACKGROUND OF THE INVENTION

As contactless cards become increasingly popular, people get used to the tremendous convenience of this kind of cards such as credit cards or cash cards, and we no longer need to carry too much cash. As long as a store or a vending machine has a card reader, we can make purchases by the restored dollar amount of a card or the credit limit of a credit card. However, the present cards can read the content of data in the cards only, but cannot identify user's identity. If a user purchases a product that has a minimum age requirement, such as alcohols or cigarettes, then the card reader will not be able to provide the related information, and thus a storekeeper have to determine whether or not a consumer exceeds the minimum age requirement by the consumer's appearance or request the consumer to show an identity card. For vending machines, it will be unable to identify a consumer's age. At present, the multi-card reader capable of reading contactless cards and the identity data usually comes with a high price, and thus much cost is incurred to update all of the card readers to have capability of identification of identity cards.

In view of the foregoing shortcomings of the prior art, the inventor of the present invention based on years of experience to conduct extensive researches and experiments, and finally developed a multiple card reading modules apparatus in accordance with the invention to overcome the foregoing shortcomings.

### SUMMARY OF THE INVENTION

Therefore, it is a primary objective of the present invention to provide a multiple card reading modules apparatus of which different card reading modules are coupled by a combination device for sharing the card input slot and the card transport channel to improve the convenience of expending the card reader.

Another objective of the present invention is to provide a multiple card reading modules apparatus that comprises a first card reading module and a second card reading module. The first card reading module has a card receiving structure for obtaining a first card, and the second card reading module is connected to the first card reading module by a combination device for sharing the card receiving structure to obtain a second card.

A further objective of the present invention is to provide a multiple card reading modules apparatus that comprises a first card reading module and a second card reading module. The first card reading module has a card receiving structure for obtaining a first card signal according to a control signal, and the second card reading module is connected to the first card reading module by a combination device for sharing a card receiving structure to obtain a second card signal and generate a control signal according to the content of the second card signal.

### BRIEF DESCRIPTION OF THE DRAWINGS

FIG. 1 is a block diagram of a multiple card reading modules apparatus according to a preferred embodiment of the present invention;

FIG. 2 is a schematic view of a multiple card reading modules apparatus according to a preferred embodiment of the present invention;

FIG. 3 is a block diagram of a multiple card reading modules apparatus according to another preferred embodiment of the present invention; and

FIG. 4 is a block diagram of a multiple card reading modules apparatus according to another preferred embodiment of the present invention.

### DETAILED DESCRIPTION OF THE PREFERRED EMBODIMENTS

To make it easier for our examiner to understand the present invention, a detail description of a preferred embodiment of the multiple card reading modules apparatus with reference to the accompanying drawings is given, wherein the same elements in the following embodiment bear the same respective numerals.

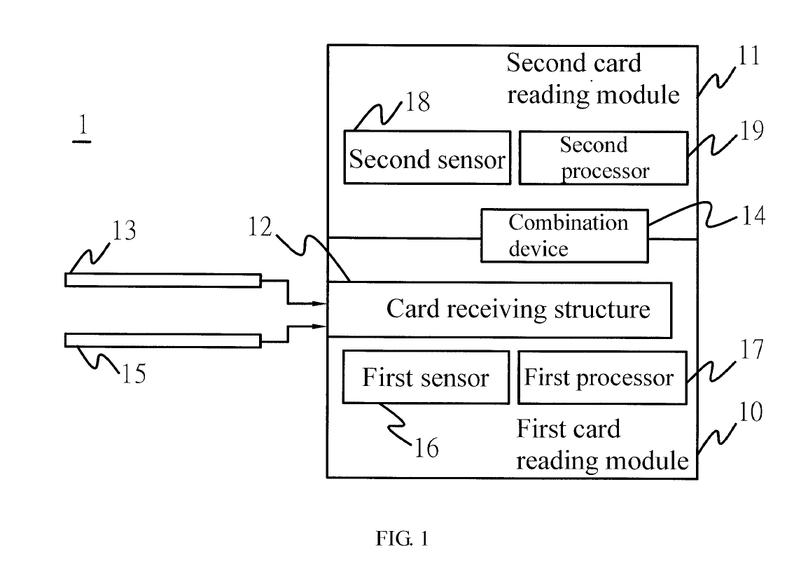

Referring to FIG. 1 for the block diagram of a multiple card reading modules apparatus according to a preferred embodiment of the present invention, the multiple card reading modules apparatus 1 comprises a first card reading module 10 and a second card reading module 11. The first card reading module 10 has a card receiving structure 12 for reading a first card 13, and the second card reading module 11 is coupled to the first card reading module 10 by a combination device 14 for sharing the card receiving structure 12 to read a second card 15. The first card reading module 10 and second card reading module 11 have separate sensors and processors.

In FIG. 1, the first card reading module 10 includes a first sensor 16 and a first processor 17. The first sensor 16 is provided for detecting and reading the data of the first card 13, and the first processor 17 processes the data read by the first sensor 16. The second card reading module 11 includes a second sensor 18 and a second processor 19, and the second sensor 18 is provided for detecting and reading the data of the second card 16, and the second processor 19 processes the data read by the second sensor 18.

The card receiving structure 12 includes a card input slot and a card transport channel, and the card input slot is provided for inputting a card by a user, and the card transport channel is provided for transporting a card, such that the first sensor and the second sensor can detect and read the data of the card.

The first card reading module is preferably a credit card reader, and the first card is preferably a credit card, a financial card or a stored value card. The second card reading module is preferably a card reader, and the second card preferably comprises a card having an identity data such as an identity card, a passport or a driver's license, etc. The identity data could be a name, a sex, a nationality, an age or a residential address. The combination device is preferably a latch device or a lock device.

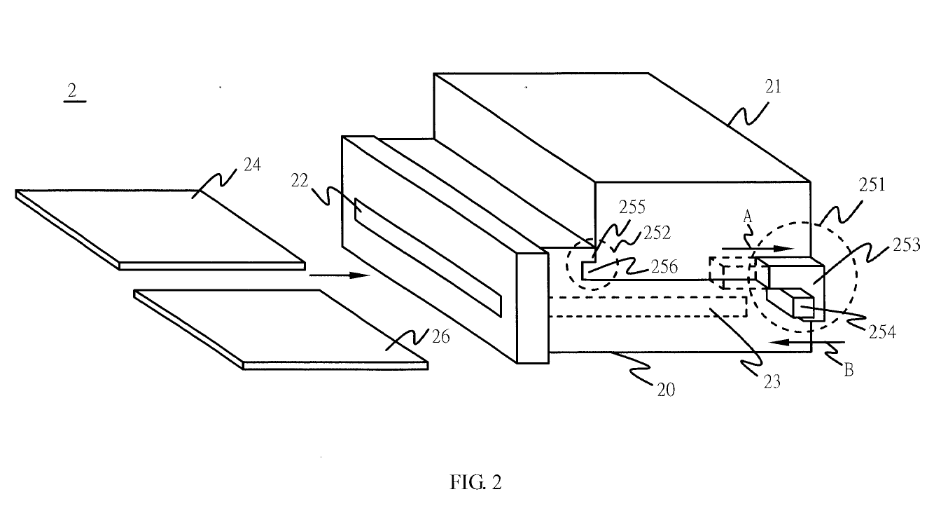

Referring to FIG. 2 for a schematic view of a multiple card reading modules apparatus according to a preferred embodiment of the present invention, the multiple card reading modules apparatus 2 comprises a credit card reader 20 and a card reader 21. The credit card reader 20 includes a card input slot 22 and a card transport channel 23, and users can input a credit card 24 into the card input slot 22, and the card transport channel 23 is provided for transporting the credit card 24 into the credit card reader 20 to read the data of the credit card 24. The card reader 21 is connected to the credit card reader 20 by the latch device 251, 252 (as shown in the dotted circles in the figure), so that the credit card reader 20 can share the card input slot 22 and the card transport channel 23. Users can input an identity data card 26 such as an identity card, a passport or a driver's license into the card input slot 22, and the card reader 21 can read the data of the identity data card 26 when the identity data card 26 is transported in the card transport channel 23.

The latch device 252 includes an indented device 255 disposed on a casing of the credit card reader 20 and a protruding device 256 disposed on the casing of the card reader 21. The latch device 251 includes a cylindrical device 254 disposed on the casing of the credit card reader 20 and a hook 253 disposed on the casing of the card reader 21, and the hook 253 is equipped with an elastic element, such that when the hook 253 is moved in a direction A, the elastic element will produce a pulling force in a direction B. When the credit card reader 20 and the card reader 21 are going to be connected, the indented device 255 and the protruding device 256 are connected first, and then the hook 253 is pulled along the direction A to latch the hook 253 to the cylindrical device 254, such that the card reader 21 can be fixed onto the credit card reader 20. Further, the casing of the credit card reader 20 has screw holes disposed on the card reader 21 for securing the credit card reader 20 and the card reader 21 by screws.

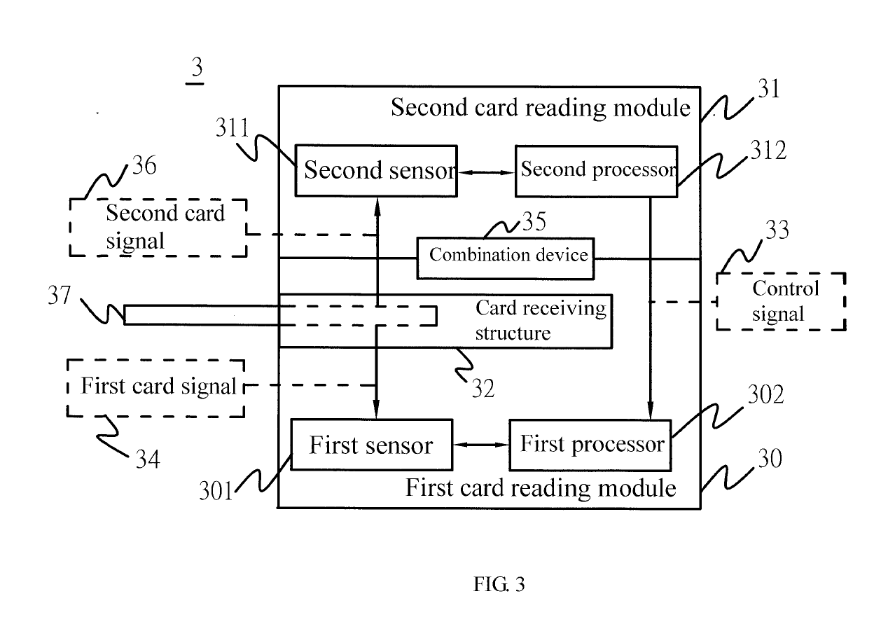

Referring to FIG. 3 for a block diagram of a multiple card reading modules apparatus according to another preferred embodiment of the present invention, the multiple card reading modules apparatus 3 comprises a first card reading module 30 and a second card reading module 31. The first card reading module 30 includes a card receiving structure 32 for obtaining a first card signal 34 according to a control signal 33. The second card reading module 31 is connected to the first card reading module 30 by a combination device 35 for sharing the card receiving structure 32 to obtain a second card signal 36 and producing a control signal 33 according to the content of the second card signal 36. The first card signal 34 and second card signal 36 could come from the same card 37 or could be read from different cards.

Referring to FIG. 3, the second card reading module 31 includes a second sensor 311 and a second processor 312. The second sensor 312 is provided for reading the second card signal 36 of the card 37, and the second processor 19 performs a computation according to the content of the second card signal 36 to produce a control signal 33. The first card reading module 30 includes a first sensor 301 and a first processor 302, and the first sensor 301 is provided for reading the first card signal 34 of the card 37, and the first processor 302 determines whether or not to compute the content of the first card signal 34 according to the control signal 33.

The first card reading module 30 is preferably a credit card reader, and the first card signal 34 comes from a credit card, a financial card or a stored value card. The second card reading module 31 is preferably a card reader, and the second card signal 36 comprises a card with an identity data such as an identity card, a passport or a driver's license, etc. The identity data could be a name, a sex, a nationality, an age or a residential address. The combination device 35 is preferably a latch device or a lock device.

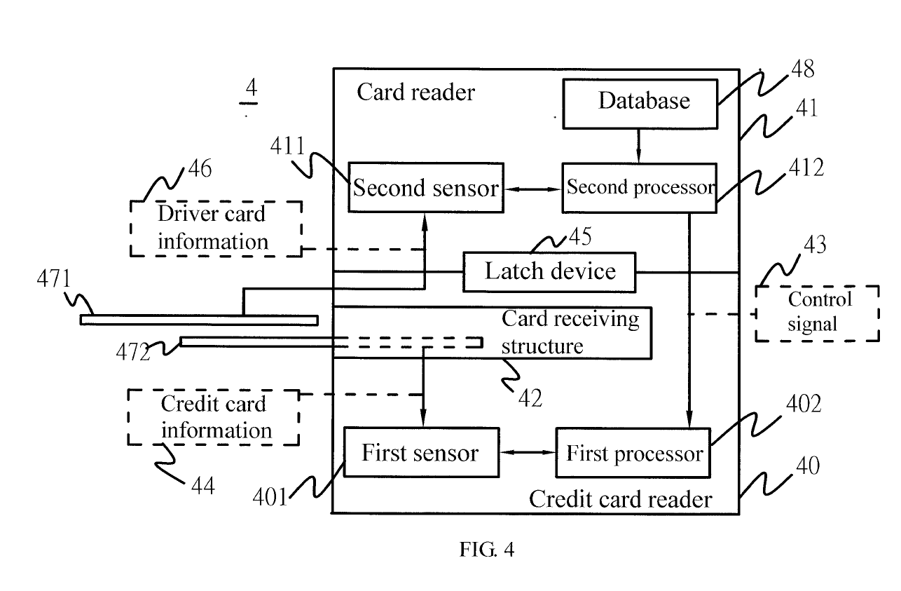

Referring to FIG. 4 for a block diagram of a multiple card reading modules apparatus of another preferred embodiment of the present invention, the multiple card reading modules apparatus 4 comprises a credit card reader 40 and a card reader 41. The credit card reader 40 includes a card receiving structure 42, a first sensor 401 and a first processor 402. The card reader 41 includes a second sensor 411 and a second processor 412, and the card reader 41 is connected to the credit card reader 40 by a latch device 45. The second sensor 411 is provided for reading a driver license card signal 46 of a driver license card 471. It is noteworthy to point out that the data of the driver license card 471 is actually read after the card is inputted into the card receiving structure 42, so that the driver license card 471 is drawn outside the card receiving structure 42 as shown in FIG. 4 to indicate the different input time of the different cards.

The second processor 412 compares the driver license card signal 46 with data pre-stored in the database 48 such as comparing the age or nationality of a user to confirm whether or not the user's identity match the requirements of purchasing a product. The second processor 412 generates a control signal 43 according on the comparison result and sends the control signal 43 to the first processor 402. The first sensor 40 is provided for reading the credit card information 44 of the credit card 472. The first processor 402 determines whether or not to process the credit card information 44 according to the control signal 43.

If a user starts inputting the credit card 472 to purchase cigarettes and the second sensor 411 cannot read the identity data from the credit card 472, the second processor 412 will produce a control signal 43 to prohibit the first processor 402 from processing the credit card information 44. Now, the multiple card reading modules apparatus 4 will issue a reminder signal to remind the user to input an identity card, a passport or a driver's license to confirm the user's identity for purchasing cigarettes. The second processor 412 will produce a control signal 43 to allow the first processor 402 to process the credit card information 44, so that the user can use the credit limit remained in the credit card 472 to purchase cigarettes.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multiple card reading modules apparatus, comprising:
a first card reading module having a card receiving structure for reading a first card; and
a second card reading module, coupled to the first card reading module by a combination device for sharing the card receiving structure to read a second card.

2. The multiple card reading modules apparatus of claim 1, wherein the card receiving structure includes a card input slot and a card transport channel.

3. The multiple card reading modules apparatus of claim 1, wherein the first card reading module is a credit card reader.

4. The multiple card reading modules apparatus of claim 1, wherein the first card is a credit card or a financial card.

5. The multiple card reading modules apparatus of claim 1, wherein the second card reading module is a card reader.

6. The multiple card reading modules apparatus of claim 1, wherein the second card comprises an identity data.

7. The multiple card reading modules apparatus of claim 6, wherein the identity data is a name, a sex, a nationality, an age or a residential address.

8. The multiple card reading modules apparatus of claim 1, wherein the combination device is a latch device.

9. The multiple card reading modules apparatus of claim 1, wherein the combination device is a lock device.

10. A multiple card reading modules apparatus, comprising:
a first card reading module, having a card receiving structure for reading a first card signal according to a control signal; and
a second card reading module, coupled to the first card reading module by a combination device for sharing the card receiving structure to read a second card signal and generating the control signal according to the content of the second card signal.

11. The multiple card reading modules apparatus of claim 10, wherein the card receiving structure includes a card input slot and a card transport channel.

12. The multiple card reading modules apparatus of claim 10, wherein the first card reading module is a credit card reader.

13. The multiple card reading modules apparatus of claim 10, wherein the first card signal comes from a credit card, a financial card or a stored value card.

14. The multiple card reading modules apparatus of claim 10, wherein the second card reading module is a card reader.

15. The multiple card reading modules apparatus of claim 10, wherein the second card signal comprises an identity data.

16. The multiple card reading modules apparatus of claim 15, wherein the identity data is a name, a sex, a nationality, an age or a residential address.

17. The multiple card reading modules apparatus of claim 10, wherein the combination device is a latch device.

18. The multiple card reading modules apparatus of claim 10, wherein the combination device is a lock device.

19. A multiple card reading modules apparatus, comprising:
a credit card reader, having a card receiving structure for reading a credit card; and
a card reader, coupled to the credit card reader by a combination device, for sharing the card receiving structure to read an identity data card.

20. The multiple card reading modules apparatus of claim 19, wherein the card receiving structure includes a card input slot and a card transport channel.

21. The multiple card reading modules apparatus of claim 19, wherein the identity data card comprises an identity data.

22. The multiple card reading modules apparatus of claim 21, wherein the identity data is a name, a sex, a nationality, an age or a residential address.

23. The multiple card reading modules apparatus of claim 19, wherein the combination device is a latch device.

24. The multiple card reading modules apparatus of claim 19, wherein the combination device is a lock device.

25. A multiple card reading modules apparatus, comprising:
a credit card reader, having a card receiving structure for reading a credit card data information according to a control signal; and
a card reader, coupled with the credit card reader by a combination device, for sharing the card receiving structure to read an identity data card information and generating the control signal according to the content of the identity data card information.

26. The multiple card reading modules apparatus of claim 25, wherein the card receiving structure includes a card input slot and a card transport channel.

27. The multiple card reading modules apparatus of claim 25, wherein the credit card data information comes from a credit card, a financial card or a stored value card.

28. The multiple card reading modules apparatus of claim 25, wherein the identity data card information is a name, a sex, a nationality, an age or a residential address.

29. The multiple card reading modules apparatus of claim 25, wherein the combination device is a latch device.

30. The multiple card reading modules apparatus of claim 25, wherein the combination device is a lock device.
